(19) United States
(12) Patent Application Publication
(10) Pub. No.: US 2019/0244553 A1
(43) Pub. Date: Aug. 8, 2019

(54) HEAD-UP DISPLAY AND METHOD FOR CONTROLLING AN IMAGE-GENERATION DEVICE OF A HEAD-UP DISPLAY

(71) Applicant: VALEO COMFORT AND DRIVING ASSISTANCE, Créteil (FR)

(72) Inventor: Michael Irzyk, Créteil (FR)

(73) Assignee: VALEO COMFORT AND DRIVING ASSISTANCE, Créteil (FR)

(21) Appl. No.: 16/315,669

(22) PCT Filed: Jun. 30, 2017
(86) PCT No.: PCT/EP2017/066399

§ 371 Date: Apr. 12, 2019

(30) Foreign Application Priority Data
Jul. 5, 2016 (FR) 1656442

(51) Int. Cl. G09G 3/00; G02B 27/01; B60K 35/00

(52) U.S. Cl. CPC G09G 3/002; G08G 1/09626; B60K 35/00; G02B 27/0101

(57) ABSTRACT

The invention relates to a method for controlling an image-generation device (11) of a head-up display (10) for a motor vehicle, comprising: a step of acquiring data relating to the operation and/or the environment of the motor vehicle, and a step of controlling the display, via the image-generation device, of at least two driving-assistance information items, based upon the acquired data. According to the invention, during the control step, the light intensity of at least one information item is time-modulated with respect to the light intensity of the other information item. The invention also relates to a head-up display comprising a computer capable of performing the above-mentioned method.

### TECHNICAL FIELD TO WHICH THE INVENTION RELATES

The present invention relates generally to motor vehicle driving aid devices.

It relates more particularly to a method for controlling an image-generating device of a head-up display for a motor vehicle, comprising:
a step of acquisition of data relating to the operation and/or to the environment of the motor vehicle, and
a step of generation of an image, by the image-generating device, comprising at least two items of driving aid information, based on the acquired data.

It relates also to a head-up display for a motor vehicle, comprising:
an image-generating device,
a system for projecting a virtual image into the visual field of the driver of the motor vehicle, and
a computer adapted to acquire data relating to the operation and/or to the environment of the motor vehicle, and to control the image-generating device in such a way that it generates an image comprising at least two items of driving aid information, based on the acquired data.

### TECHNOLOGICAL BACKGROUND

To facilitate and make the driving of a motor vehicle safer, it is desirable to avoid having the driver be forced to divert his or her gaze from the road that he or she is taking.

For that, it is known practice to use a head-up display, adapted to project information (speed of the vehicle, direction to be taken, malfunction of the engine, presence of obstacles, etc.) at the height of the gaze of the driver.

Two types of head-up displays are known in particular.

The displays of the first type use an image forming device comprising a diffuser and a scanning unit designed to generate a light beam scanning an input face of the diffuser. The light beam at the output of the diffuser thus forms an image, which can then be projected into the visual field of the driver of the vehicle.

The displays of the second type use a screen which makes it possible to generate an image, which is then projected into the visual field of the driver.

The variety of information that can be projected into the visual field of the driver is so great that those items of information which seem the most useful to the driver must be selected. In fact, it is possible to display information relating to the operation of the vehicle (speed, petrol level, automatic regulation speed), or guidance information (road to be taken, distance to next turn-off, name of the road being taken, risk of traffic jam, etc.), or even safety information (highlighting of obstacles, speed limit, etc.).

Currently, only a few rare items of information are selected to be projected into the visual field of the driver in order to not overload the driver with information and not disturb him or her in his or her driving.

The head-up displays therefore present two major ergonomic constraints.

The first constraint is the number of items of information projected into the visual field of the driver must remain limited.

The second constraint is that, in the presence of numerous items of information that are fixed in terms of content, of form, of brightness, the driver becomes accustomed to them and no longer watches out for the information which could, at a given moment, be particularly important.

### OBJECT OF THE INVENTION

In order to remedy the abovementioned drawbacks of the state of the art, the present invention proposes progressively clearing the items of information with no added value, so that only the useful items of information remain in the visual field of the driver.

More particularly, there is proposed, according to the invention, a control method as defined in the introduction, in which, in the control step, provision is made to temporally modulate the light intensity of at least one item of information relative to the light intensity of the other item of information (the latter being able to be considered equal to a reference nominal light intensity).

Thus, by virtue of the invention, it is possible to reduce the light intensity of the less important items of information, to highlight only those which must be considered as a priority by the driver of the vehicle.

It is even possible to clear, at least momentarily, some items of information once they are no longer important. It will also be possible to show new items of information when they are deemed important.

It is therefore understood that it will be possible to project into the visual field of the driver a great number of items of information, but at different moments.

Preferably, the elimination of information will be done progressively, so as not to pointlessly draw the eye of the driver. On the contrary, the display of new important items of information will preferably be done fairly rapidly, to draw the eye of the driver.

Other advantageous and nonlimiting features of the control method according to the invention are as follows:
in the control step, provision is made to continuously modulate the light intensity of said item of information;
in the acquisition step, provision is made to acquire the value of at least one parameter relating to the traffic conditions of the motor vehicle, and, in the control step, provision is made to modulate the light intensity of said item of information based on the variations of the value of said parameter;
in the control step, the light intensity of said item of information is modulated to vary between a maximum intensity level and a minimum intensity level;
provision is made to vary the light intensity of said item of information faster when the light intensity is increased than when the light intensity is reduced;
as long as the value of said parameter remains substantially constant, the light intensity of said item of information is controlled to remain equal to the minimum intensity level, and, as soon as the value of said parameter varies substantially, the light intensity of said item of information is increased to the maximum intensity level where it is maintained constant, then, as soon as the value of said parameter has remained substantially constant for a predetermined time, the light intensity of said item of information is reduced to the minimum intensity level.

The invention also proposes a head-up display as defined in the introduction, in which the image-generating device is adapted to independently vary the light intensity of each item of information, and in which the computer is adapted to control the image-generating device in such a way as to temporally modulate the light intensity of each item of information relative to one another.

Other advantageous and nonlimiting features of the head-up display according to the invention are as follows:
the computer is adapted to acquire the value of at least one parameter relating to the traffic conditions of the motor vehicle and to vary the light intensity of one of the items of information in light of the variations of the value of said parameter;
the computer is adapted to vary the light intensity of one of the items of information between a maximum intensity level and a minimum intensity level.

### DETAILED DESCRIPTION OF AN EXEMPLARY EMBODIMENT

The description which follows, in light of the attached drawings, given by way of nonlimiting examples, will give a good understanding of what the invention consists of and how it can be produced.

In the attached drawings:

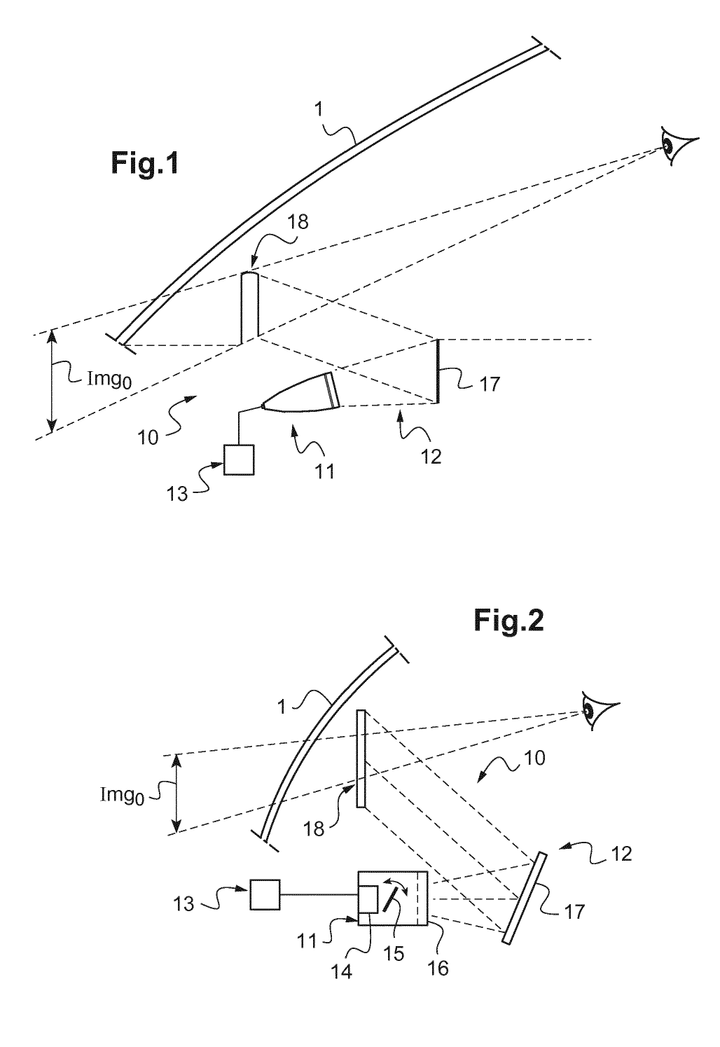

FIG. 1 is a schematic view of a first embodiment of a head-up display according to the invention;

FIG. 2 is a schematic view of a second embodiment of a head-up display according to the invention;

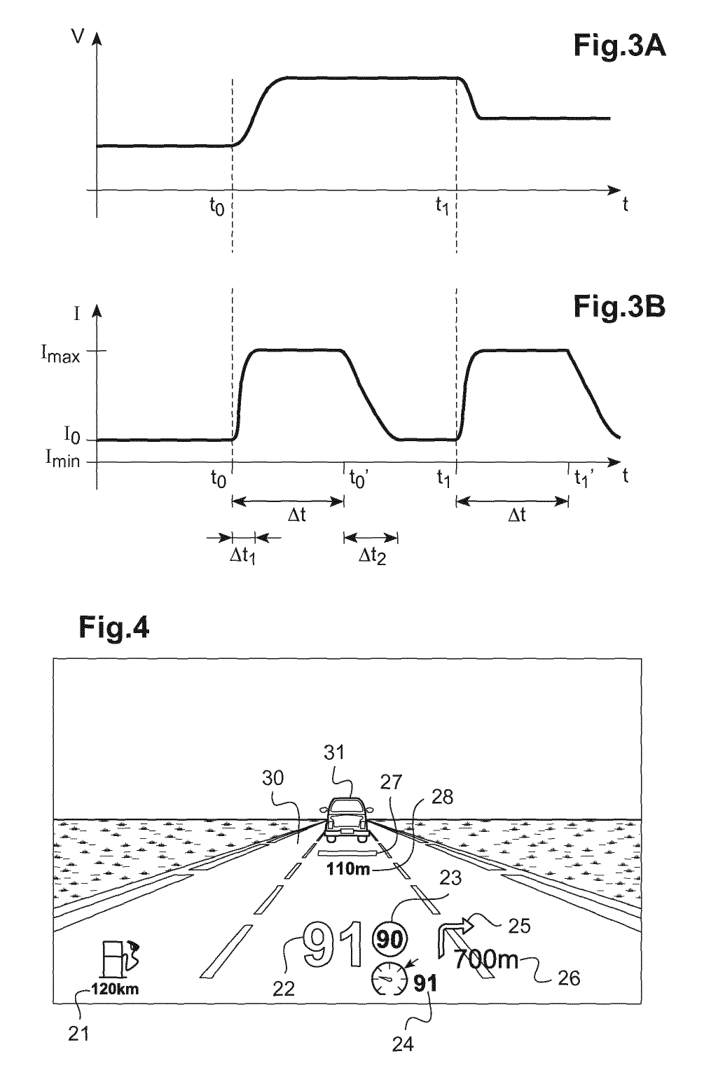

FIGS. 3A and 3B are synchronous graphs illustrating the variation in time of the speed of a motor vehicle (FIG. 3A) and of the light intensity of an item of information appearing on an image generated by a head-up display (FIG. 3B); and

FIG. 4 is a schematic view of an image generated by a head-up display.

In FIGS. 1 and 2, two embodiments of a head-up display 10 intended to equip a vehicle, for example a motor vehicle, have been represented.

In these two embodiments, the head-up display 10 comprises an image-generating device 11 controlled by a computer 13, and an optical projection assembly 12.

In the first embodiment illustrated in FIG. 1, the image-generating unit 11 is of the “light modulation” type. It comprises a screen, here a liquid crystal screen (or LCD, standing for “Liquid Crystal Display”) with thin-film transistors (TFT). Here, it also comprises a backlighting device situated behind the screen. This backlighting device comprises a plurality of light-emitting diodes distributed behind the liquid crystals of the screen.

In the second embodiment illustrated in FIG. 2, the image-generating unit 11 is of the “emissive” type. It comprises a diffuser 16 and a scanning unit which generates a light beam of variable direction so as to be able to scan the rear face of the diffuser 16. The scanning unit more specifically comprises a beam-forming module 14 and a mobile mirror 15, for example produced in the form of a microelectromechanical system (or MEMS).

The beam-forming module 14 typically comprises three monochromatic light sources, such as laser sources, whose respective light beams (monochromatic) are combined (for example using dichroic mirrors) in order to form the polychromatic light beam (here laser) emitted at the output of the beam-forming module 14. This light beam generated by the beam-forming module 14 is directed toward the mobile mirror 15, whose orientation is controlled by a control module in such a way that the reflected light beam (reflected by the mobile mirror 15) scans the rear face of the diffuser 16.

In these two embodiments, the image-generating unit 11 makes it possible, under the control of the computer 13, to generate an image that the optical projection assembly 12 will be able to project into the visual field of the driver when the gaze thereof is turned toward the road.

In the two embodiments represented in FIGS. 1 and 2, the optical projection assembly 12 is more specifically designed to project a virtual image Img₀ into the visual field of the driver of the vehicle, at a distance from the driver which is greater than that separating the driver from the windshield 1 (so that the eyes of the driver do not have to perform the work of focusing to perceive the projected items of information).

The optical projection assembly 12 to this end comprises a return optical system 17 and a combiner 18 placed in the visual field of the driver of the vehicle.

The return optical system 17, which here comprises only a fold back mirror, makes it possible to return the image generated by the image-generating device 11 to the combiner 18.

The combiner 18 makes it possible to reflect this image in such a way that it appears to the driver as if it were displayed outside the vehicle.

Here, this combiner 18 is formed by a semi-reflecting plate which is arranged in the interior of the motor vehicle, between the windshield 1 of the vehicle and the eyes of the driver, and which is curved so as to enlarge the size of the virtual image Img₀ seen by the driver.

As a variant, the semi-reflecting element could be the windshield itself.

In the two embodiments represented in FIGS. 1 and 2, the computer 13 is designed to control the image-generating unit 11, in such a way that the head-up display 10 can project useful items of information into the visual field of the driver.

This computer 13 comprises a processor (CPU), a RAM memory, a ROM memory, analogue-digital (ND) converters, and various input and output interfaces.

By virtue of its input interfaces, the computer 13 is adapted to receive input signals originating from different sensors or other computers. As an example, the computer 13 will be able to be connected to the main communication network of the vehicle (of BUS-CAN type), in order to be able to read therefrom the data sought.

The computer 13 can thus acquire various data relating to the operation and/or to the environment of the motor vehicle.

It thus acquires data relating to the operation of the vehicle, such as, for example:
the instantaneous speed V of the motor vehicle,
the remaining fuel level,
the regulation speed chosen by the driver in the automatic speed regulator.

These data are for example acquired via sensors with which the vehicle is equipped.

The computer 13 also acquires vehicle guidance data, such as, for example:
the road to be taken,
the distance to the next change of traffic lane,
the name of the road taken,
the presence of a traffic jam,
the time and distance remaining before arrival destination.

These data are for example acquired via a navigation and geolocation system with which the vehicle is equipped.

The computer 13 finally acquires data relating to the safety of the vehicle, such as, for example:
the presence of an obstacle and the distance to each obstacle (obtained for example using a camera or using a sensor of RADAR or LIDAR type),
the speed limit Vmax allowed on the traffic lane taken (obtained for example using a camera which films the roadside signs, or using the navigation and geolocation system).

These input signals are, if necessary, sampled and digitized. They are then stored in the RAM memory of the computer 13.

The ROM memory, for its part, stores the data used in the context of the method described below.

It stores in particular a computer application, composed of computer programs comprising instructions whose execution by the processor allows the implementation by the computer 13 of the method described hereinbelow.

Finally, by virtue of its output interfaces, the computer 13 is adapted to transmit control signals to the image-generating device 11, so that the latter generates an image comprising different distinct items of information, useful for the driving of the motor vehicle.

In FIG. 4, to clearly illustrate the present invention, it has been schematically represented that the driver can see through the combiner 18.

He or she can first of all observe the road 30 which extends in front of him or her and on which, here, a motor vehicle 31 is travelling in front.

He or she can also see, superimposed on the road 30, the virtual image Img₀ generated by the image-generating device 11.

In the particular embodiment represented in FIG. 4, several items of “information” are identified on this virtual image Img₀, namely:
an item of fuel level information 21, which corresponds to an estimation of the distance that can still be traveled before running out of petrol,
an item of instantaneous speed information 22, which corresponds to the instantaneous speed of the motor vehicle (this speed being possibly previously filtered, so as not to take account of disturbances or insignificant speed variations),
an item of speed limit information 23 which corresponds to the speed limit authorized on the road taken (this information being equal to the speed limitation Vmax acquired by the computer),
an item of regulation speed information 24, which corresponds to the speed that the driver has programmed on his or her speed regulator,
an item of direction information 25 which corresponds to the direction of the next turn-off,
an item of information on distance before turn-off 26 which corresponds to the distance separating the vehicle from the next turn-off,
an item of obstacle information 27 here presented in the form of a line highlighting the presence of an obstacle, namely, here, the motor vehicle 31, and
an item of distance information 28 which corresponds to the distance separating the vehicle from this obstacle.

According to a particularly advantageous feature of the invention, the computer 13 is adapted to control the image-generating device 11 in such a way as to temporally modulate the light intensity of at least one item of information relative to the light intensity of the other items of information.

For that, the image-generating device 11 is adapted to independently vary the light intensity of each item of information on the virtual image Img₀.

In the case of the first embodiment represented in FIG. 1, this variation of light intensity can for example be done by varying the light intensity emitted by some of the light-emitting diodes of the backlighting device.

In the case of the second embodiment represented in FIG. 2, this variation of light intensity can for example be done by varying the light intensity emitted by some or all of the monochromatic light sources.

Whatever the case, the computer 13 is adapted to control the image-generating device 11 by transmitting to it a set point comprising data relating to the form of the image to be displayed and data relating to the light intensity with which the different parts of the image must appear.

There now follows a description of an exemplary control algorithm implemented by the computer 13 to control the image-generating device 11 accordingly.

The algorithm presented here will be repeated at regular and short time intervals.

During a first step of this algorithm, the computer 13 acquires the data relating to the operation and/or to the environment of the motor vehicle (listed previously). It acquires in particular the instantaneous speed V of the motor vehicle, and the speed limitation Vmax authorized on the traffic lane taken by the vehicle.

During a second step, the computer 13 processes all the acquired data so as to deduce therefrom items of driving aid information 21 to 28 (listed previously), likely to be projected into the visual field of the driver.

During a third step, the computer 13 generates an image which comprises said items of driving aid information 21 to 28, then it computes and assigns each of these items of information a light intensity. This light intensity corresponds to the intensity with which the corresponding item of information must be displayed.

According to the invention, the computer 13 temporally modulates the light intensity of at least one of these items of driving aid information 21 to 28.

For that, it will for example be possible to focus, by way of illustration, on the manner in which the computer 13 computes the light intensity of the three items of information that are the item of instantaneous speed information 22, the item of speed limitation information 23 and the item of fuel level information 21.

Since the item of instantaneous speed information 22 is considered to be essential at all times, its light intensity I₂₂ is set so as to remain constantly equal to a maximum intensity Iₘₐₓ.

As will be clearly described hereinbelow in this description, this maximum intensity Iₘₐₓ may be invariable or may, on the contrary, vary, for example according to the ambient brightness conditions.

The item of fuel level information 21 is, for its part, considered as essential only when the distance that can still be traveled before running out of fuel passes below a predetermined threshold (for example 200 kilometers). Consequently, its light intensity I₂₁ is set equal to zero as long as said distance remains above this threshold, then it is set equal to the maximum intensity Iₘₐₓ when said distance passes below this threshold.

The item of speed limit information 23 is, for its part, considered as sometimes essential, given the traffic conditions of the motor vehicle. Consequently, its light intensity I₂₃ is temporally modulated based on a parameter relating to the traffic conditions of the motor vehicle.

More specifically, in the exemplary embodiment considered, the item of speed limit information 23 is considered as essential only when the speed limit Vmax changes. Consequently, its light intensity I₂₃ is temporally modulated according to the speed limit Vmax variations.

To clearly illustrate the invention, FIG. 3A shows the trend of the instantaneous speed V of the motor vehicle. It can first of all be explained that, at the instant t₀, the speed limitation Vmax increases, since it decreases at the instant t₁.

It is then observed on this same FIG. 3A that the instantaneous speed V of the vehicle changes to adapt to these speed limitation changes, with a slight delay.

FIG. 3B shows, synchronously, the corresponding variation of the light intensity I₂₃ assigned by the computer 13 to the item of speed limit information 23.

As clearly shown in this FIG. 3B, a choice is made here to display the item of speed limitation information 23 after each change of speed limit Vmax, then to clear this information after a predetermined time Δt, if the speed limit Vmax has not changed during this predetermined time Δt.

The light intensity I₂₃ is more specifically modulated to vary between a maximum intensity level Iₘₐₓ and a minimum intensity level I₀.

Thus, as FIG. 3B shows, initially, then as long as the speed limit Vmax remains unchanged, the light intensity I₂₃ is controlled to remain equal to the minimum intensity level I₀.

Then, as soon as the speed limit Vmax changes (at the instants t₀ and t₁), the light intensity I₂₃ is increased up to a maximum intensity level Iₘₐₓ where it is maintained constant at least during the time Δt.

Then, when the speed limit Vmax has remained constant for this time Δt, the light intensity I₂₃ is progressively reduced to the minimum intensity level I₀.

Here, to avoid any visual interference for the driver the variation of the light intensity I₂₃ of the item of speed limitation information 23 is continuous (and not abrupt, in levels).

As FIG. 3B shows, provision is made to vary the light intensity I₂₃ faster when wanting to increase it (at the instants t₀ and t₁, after a change of speed limit Vmax) than when wanting to reduce it (at the instants t₀′ and t₁′, when the speed limit has not changed during the time Δt).

In this way, the driver of the vehicle will not be disturbed by the progressively clearing of the speed limitation information 23. On the other hand, his or her gaze will be drawn by the more sudden appearance of the item of speed limitation information 23.

The brightness transition between the levels can be given in the form:

$${I}_{23} = {I}_{H} \cdot ( \frac{1 - {I}_{0}^{′}}{1 - {e}^{- \frac{t - {t}_{i}}{{α}_{i}}}} + {I}_{0}^{′} )$$

In this equation, tᵢ will be equal to the instant from which the light intensity I₂₃ begins to vary upon a change of levels (in FIG. 3B, these will successively be the instants t₀, t₀′, t₁, t₁′).

The constant I_{H} corresponds to the maximum intensity that the image-generating device 11 can provide.

The coefficient αᵢ will, for its part, be chosen such that the brightness transition takes place more or less rapidly. In practice, this coefficient αᵢ will be chosen to be greater at the instants t₀ and t₁ (upon a change of speed limitation Vmax) than at the instants t₀′ and t₁′

The coefficient I′₀ will, for its part, lie between 0 and 1 (bounds included). Its value may be modified to take account of the ambient brightness. It will for example be able to be reduced in nighttime display mode and increased in daytime display mode.

It will be noted that, in this case, this change of light intensity will simultaneously affect all the items of information displayed, and not only some of them. In other words, the value of the maximum intensity Iₘₐₓ assigned to the items of instantaneous speed 22 and fuel level 21 information will vary in the same way, to take account of the ambient brightness.

The present invention is in no way limited to the embodiment described and represented, but the person skilled in the art will be able to add any variant in accordance with its spirit.

Thus, it will in particular be possible to provide for the parameter that is taken into account to control the intensity I₂₃ not to be the speed limit Vmax, but rather the instantaneous speed V of the vehicle. Thus, as long as the instantaneous speed of the vehicle remains “substantially constant” (that is to say as long as the speed differences remain below a determined threshold for a given time period), the intensity I₂₃ can be maintained at a low level. On the other hand, it is possible to provide for the intensity I₂₃ to be increased as soon as the speed of the vehicle changes greatly. The advantage of this solution is that if the speed limit Vmax has not changed but that, for any reason, the vehicle accelerates abruptly, the item of speed limit information 23 will be once again displayed in order to remind the driver of the speed limit Vmax.

It would equally be possible to provide for the intensity of the items of vehicle guidance information (for example the item of direction information 25, the item of distance before turn-off information 26, the item of information on the name of the road taken, etc.) to be varied. Thus, by way of example, it will be possible to provide for the item of distance before turn-off information 26 to be displayed only periodically and/or on approaching this turn-off. As another example, it will be possible to display the name of the road taken only when the vehicle is traveling in a built-up area.

1. A method for controlling an image-generating device of a head-up display for a motor vehicle, comprising:
acquisition of data relating to the operation and/or to the environment of the motor vehicle; and
generation of an image, by the image-generating device, comprising at least two items of driving aid information, based on the acquired data,
provision is made to temporally modulate the light intensity of at least one item of information relative to the light intensity of another item of information.

2. The control method as claimed in claim 1, wherein, when generating the image, provision is made to continuously modulate the light intensity of said item of information.

3. The control method as claimed in claim 1, wherein:
when acquiring the data, provision is made to acquire the value of at least one parameter relating to the traffic conditions of the motor vehicle, and
when generating the image, provision is made to modulate the light intensity of said item of information based on the variations of the value of said parameter.

4. The control method as claimed in claim 3, wherein the light intensity of said item of information is modulated to vary between a maximum intensity level and a minimum intensity level.

5. The control method as claimed in claim 4, wherein:
as long as the value of said parameter remains substantially constant, the light intensity of said item of information is controlled to remain equal to the minimum intensity level, and
as soon as the value of said parameter varies substantially, the light intensity of said item of information is increased to the maximum intensity level where it is maintained constant, then, as soon as the value of said parameter has remained substantially constant for a predetermined time, the light intensity of said item of information is reduced to the minimum intensity level.

6. The control method as claimed in claim 4, wherein provision is made to vary the light intensity of said item of information faster when the light intensity is increased than when the light intensity is reduced.

7. A head-up display for a motor vehicle, comprising:
an image-generating device;
a system for projecting a virtual image into the visual field of the driver of the motor vehicle; and
a computer for acquiring data relating to the operation and/or to the environment of the motor vehicle, and to control the image-generating device to generate an image comprising at least two items of driving aid information, based on the acquired data,
wherein the image-generating device independently varies the light intensity of each item of information, and controls the image-generating device to temporally modulate the light intensity of each item of information relative to one another.

8. The head-up display as claimed in claim 7, wherein the computer acquires the value of at least one parameter relating to the traffic conditions of the motor vehicle and to temporally modulate the light intensity of one of the items of information in light of the variations of the value of said parameter.

9. The head-up display as claimed in claim 7, wherein the computer is adapted to vary the light intensity of one of the items of information between a maximum intensity level and a minimum intensity level.
